(19) United States
(12) Patent Application Publication
(10) Pub. No.: US 2019/0284042 A1
(43) Pub. Date: Sep. 19, 2019

(54) HEAD PRESSURE GASOLINE PUMP SYSTEM AND METHOD OF USE

(71) Applicant: Mark Aaron Ivers, Sweeny, TX (US)

(72) Inventor: Mark Aaron Ivers, Sweeny, TX (US)

(21) Appl. No.: 16/358,285

(22) Filed: Mar. 19, 2019

Related U.S. Application Data
(60) Provisional application No. 62/644,695, filed on Mar. 19, 2018.

(51) Int. Cl. B67D 7/78; B67D 7/36; B67D 7/38; B67D 7/68

(52) U.S. Cl. CPC B67D 7/78; B67D 7/68; B67D 7/38; B67D 7/36

(57) ABSTRACT

A head pressure gasoline pump system eliminates the need to raise a gas can or other container above the second so that gravity pulls the contents out. A pump raises the pressure where the gas is stored forcing it through a tube to another container.

### BACKGROUND

### 1. Field of the Invention

The present invention relates generally to fluid transfer systems, and more specifically, to pumps that transfer liquids from one location to another.

### 2. Description of Related Art

Fluid transfer systems are well known in the art and are effective means to move a gas, liquid or the like from where it is to another container or location. For example, FIG. 1 depicts a positive displacement pump system 101 having an intake chamber 103 that expands to draw in a liquid, a valve 105 that closes the intake chamber 103 trapping the liquid and then a discharge tube 107 that opens when the valve 105 is closed so that when the intake chamber 103 contracts the liquid is expelled through tube 107.

One of the problems commonly associated with pump 101 is limited use. For example, after use some liquid remains in the chamber and tube causing waste or additional cleanup.

In addition, if hazardous materials are to be moved the residue presents potential health or safety concerns.

Accordingly, although great strides have been made in the area of positive displacement pump systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a cross-sectional side view of a common positive displacement pump system;

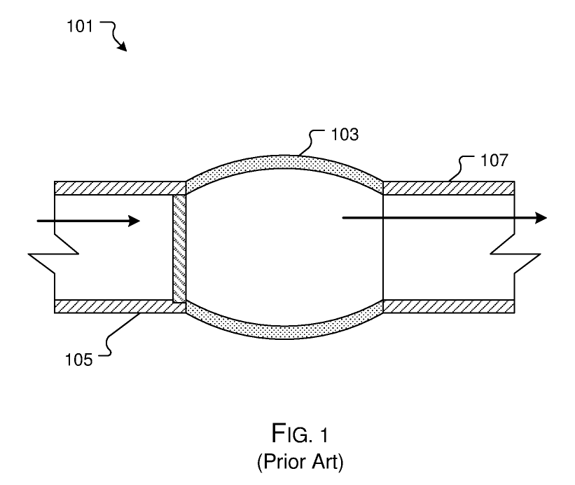

FIG. 2 is a diagram of a head pressure gasoline pump system in accordance with a preferred embodiment of the present application;

FIG. 3 is a cross-sectional side view of an alternative embodiment of the system of FIG. 2;

FIG. 4 is flowchart of the preferred method of use of the system of FIG. 2; and

FIG. 5 is a cross-sectional side view of an alternative embodiment of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional positive displacement pumps. Specifically, the invention of the present application limits the amount of liquid trapped in the system to reduce or eliminate cleanup or waste. Additionally, hazardous materials are not trapped in by the system thus eliminating or reducing health or safety concerns about moving the liquid. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

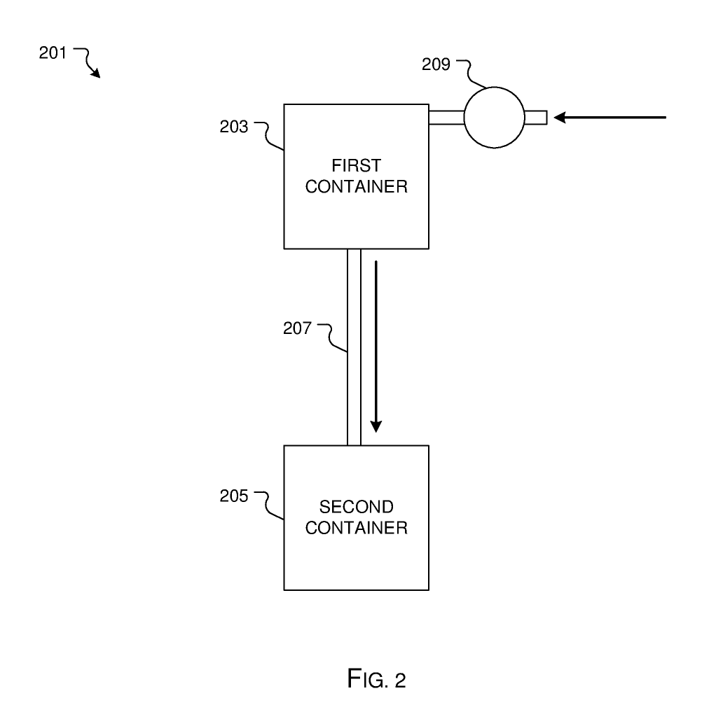

Referring now to the drawings wherein like reference characters identify corresponding or similar elements throughout the several views, FIG. 2 depicts a diagram of a head pressure gas pump system in accordance with a preferred embodiment of the present application. It will be appreciated that system 201 overcomes one or more of the above-listed problems commonly associated with conventional positive displacement pump systems.

In the contemplated embodiment, system 201 includes a first container 203 in fluid communication with a second container 205 via a tube 207. Both the first container 203 and second container 205 being configured to store gasoline. The first container having a pump 209 fixedly attached at an opening. The first container 203 being sealed so that no fluid my exit save by the tube 207. It is also contemplated that in order to relieve pressure in the first container 203, a safety valve could be used, such as are common in the art without deviating from the intent of this disclosure. For the intent of this disclosure a tube 207 is any method of placing the first container 203 in fluid communication with the second container 205. It is further contemplated that tube 207 could be of any shape or configuration.

In use, pump 209 forces air or some other fluid in the first container 203 causing the pressure to rise to force the stored gasoline through the tube 207 to the second container 205.

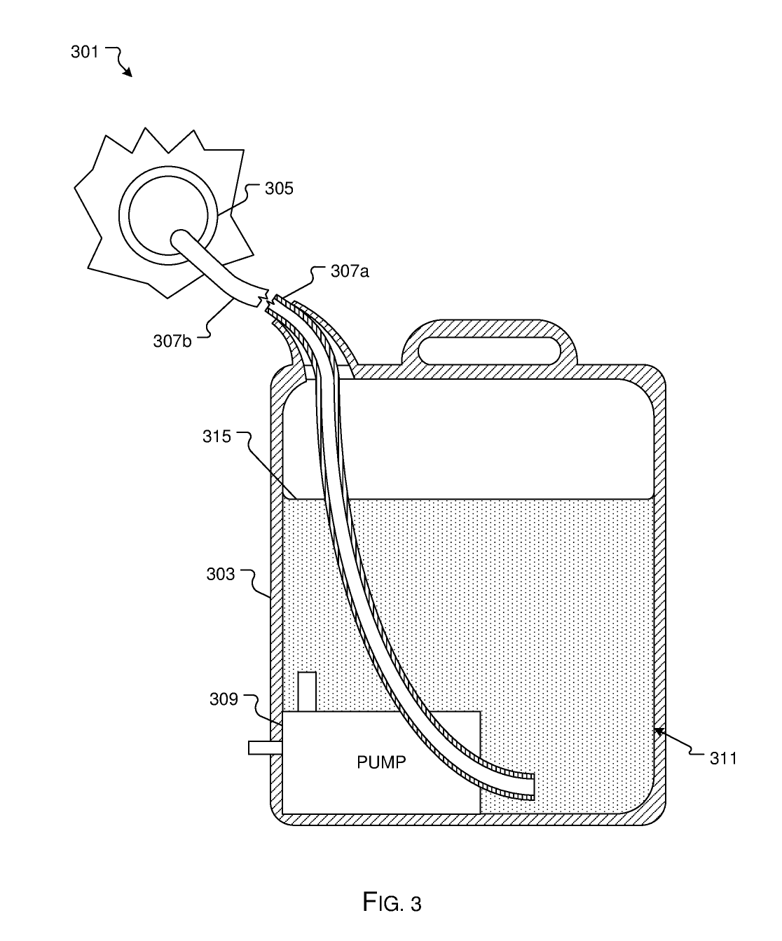

Referring now to FIG. 3 an alternative embodiment of the system 201 is depicted. Embodiment 301 having a first container 303 in fluid communication with a second container 305 via a tube 307. Both the first container 303 and second container 305 being configured to store gasoline 315. The first container having a pump 309 fixedly attached to the inside surface 311 thereof. The first container 303 being sealed so that no fluid my exit save by the tube 307.

It should be appreciated that one of the unique features believed characteristic of the present application is that there is no machinery or equipment that the gasoline must pass through to transit from the first container 203 to the second container 205.

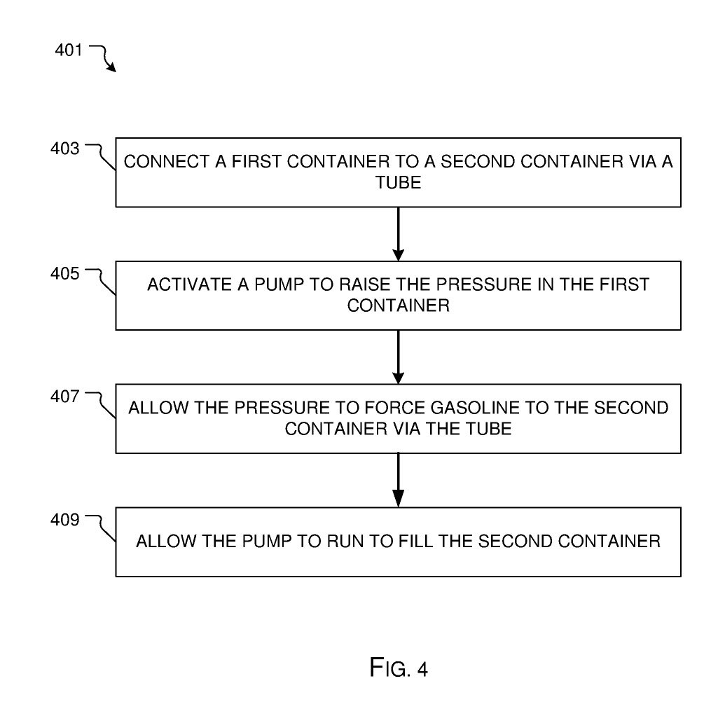

Referring now to FIG. 4 the preferred method of use of either system 201 or 301 is depicted. Method 401 including connecting the first container to the second container via the tube 403, activating the pump to raise the pressure in the first container 405, allowing the pressure to rise and force gasoline through the tube to the second container 407 and allowing the pump to run to fill the second container 409.

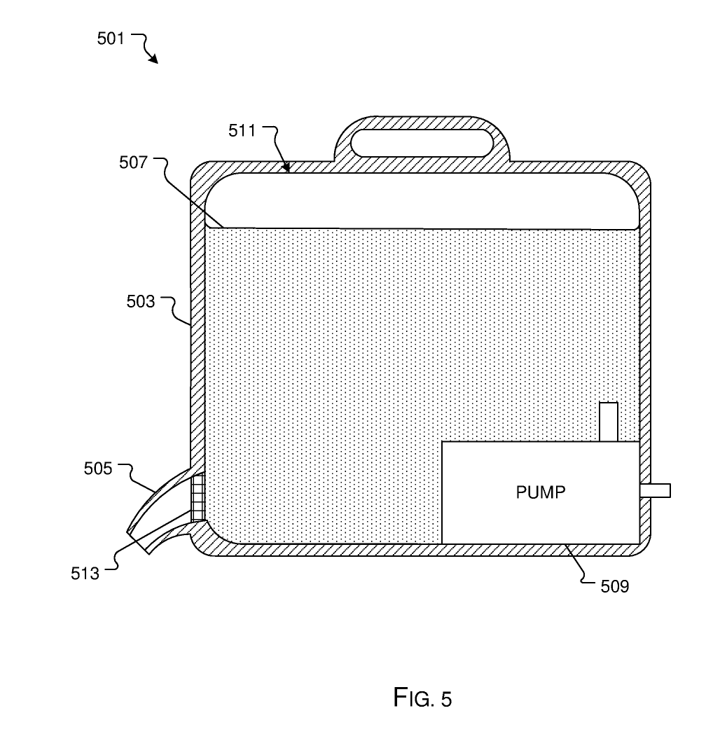

Referring now to FIG. 5 an alternative embodiment of the system 201 is depicted. Embodiment 501 having a first container 503 having a nozzle 505 extending away therefrom. The nozzle 505 having a valve 513 that prevents fluid 507 from escaping from the first container 503. The first container 503 being configured to store a fluid 507 such as gasoline. The first container 503 having a pump 509 fixedly attached to the inside surface 511 thereof.

In use, the pump 509 increased the pressure in the container 503 so that the valve 513 opens, allowing fluid to pass through the nozzle 505.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A head pressure gasoline pump system comprising:
a first container and a second container in fluid communication via a tube;
a pump attached to the first container and configured to raise the pressure thereof;
wherein fluid from the first container passes to the second container via the tube.

2. The system of claim 1 wherein the first container and second container are configured to hold gasoline.

3. A method of transferring a fluid given the system of claim 1, comprising:
connecting the first container to the second container via the tube;
activating the pump to raise the pressure in the first container;
allowing the pressure to rise and force gasoline through the tube to the second container; and
allowing the pump to run to fill the second container.

4. A head pressure gasoline pump system comprising:
a first container having a nozzle extending away from the container;
a valve configured to prevent fluid from escaping from the first container; and
a pump attached to the first container and configured to raise the pressure thereof;
wherein the valve opens when the pressure reaches a certain threshold; and
wherein fluid from the first container passes out through the nozzle.

5. The system of claim 1 wherein the first container is configured to hold gasoline.
